(19) United States
(12) Patent Application Publication
(10) Pub. No.: US 2015/0103506 A1
(43) Pub. Date: Apr. 16, 2015

(54) STROBE DEVICE

(71) Applicant: Panasonic Corporation, Osaka (JP)

(72) Inventors: Hiroyuki Yoshioka, Osaka (JP); Katsunori Kawabata, Kyoto (JP)

(21) Appl. No.: 14/385,863

(22) PCT Filed: Apr. 5, 2013
(86) PCT No.: PCT/JP2013/002363

§ 371 Date: Sep. 17, 2014

(30) Foreign Application Priority Data
Apr. 19, 2012 (JP) 2012-095336

(51) Int. Cl. G03B 15/05; F21V 13/04

(52) U.S. Cl. CPC G03B 15/05; F21V 13/04; F21W 2111/10
USPC 362/17

(57) ABSTRACT

A strobe device of the present invention includes a light source; an optical element; and reflector having reflecting surface. Reflecting surface includes first reflecting surface formed closer to reflector than from specific reflecting region in reflecting surface; and second reflecting surface formed closer to the optical element. Further, first reflecting surface has a shape curved so as to have its center of curvature inside reflector. Second reflecting surface has a shape curved so as to have its center of curvature outside reflector and to be more remote from an optical axis with decreasing distance to the optical element. This prevents light emitted from the light source from illuminating part other than a desired region.

### TECHNICAL FIELD

The present invention relates to a strobe device that illuminates a region as an imaging target.

### BACKGROUND ART

Conventionally, strobe devices have been disclosed (refer to PTL 1 for instance) that are provided directly or indirectly in imaging devices such as a digital still camera. Note that a strobe device emits light toward a region as an imaging target photographed by an imaging device.

Hereinafter, a description is made of a conventional strobe device using FIGS. 4A and 4B. FIG. 4A is a sectional view of the conventional strobe device, illustrating a state of the light source positioned closest to the reflector. FIG. 4B is a sectional view of the conventional strobe device, illustrating a state of the light source positioned most remote from the reflector.

As shown in FIGS. 4A and 4B, conventional strobe device 9 includes light source 10 formed longitudinally in one direction; optical element 11 placed in parallel with the longitudinal direction of light source 10; and reflector 13 formed longitudinally in the longitudinal direction of light source 10 and having reflecting surface 12 that reflects light from light source 10 toward optical element 11. Then, light source 10, optical element 11, and reflector 13 are arranged in the direction of optical axis A along optical axis A of strobe device 9. In this case, reflecting surface 12 of reflector 13 has its center of curvature inside and is curved in a concave shape symmetric with respect to optical axis A. Note that having a center of curvature inside means that the center of curvature is positioned closer to optical axis A than from reflecting surface 12 of reflector 13 shown in FIGS. 4A and 4B.

In strobe device 9 of the above imaging device, imaging may be performed with a region (the angle of view) as an imaging target changed. Hence, this type of strobe device 9 is usually configured so that light source 10 is displaceable relative to reflecting surface 12 of reflector 13 along the direction of optical axis A extending.

Concretely, in above strobe device 9 as shown in FIG. 4A, light source 10 closer to reflecting surface 12 of reflector 13 emits light onto a smaller region. Meanwhile, in above strobe device 9 as shown in FIG. 4B, light source 10 more remote from reflecting surface 12 of reflector 13 emits light onto a larger region.

In other words, in conventional strobe device 9, the area size of an illuminated region can be changed by displacing light source 10 relative to reflecting surface 12 of reflector 13 along the direction of optical axis A, which allows the area size of the illuminated region to be adjusted in response to the area size of a region as an imaging target.

In this case, for conventional strobe device 9 to protect optical element 11 from heat generated by light emission from light source 10, light source 10 and optical element 11 are placed a given distance (i.e., space 20) apart. This may cause upsizing of strobe device 9 and a smaller illuminated region. To avoid this situation, conventional strobe device 9 uses optical element 11 with strong refractive power, which prevents upsizing of strobe device 9 while achieving a large illuminated region.

Using optical element 11 with strong refractive power, however, may excessively expand an illuminated region as shown in FIG. 4B. This causes illuminating part other than a region as an imaging target, which undesirably prevents conventional strobe device 9 from illuminating an entire region as an imaging target with an appropriate amount of light.

### CITATION LIST

### Patent Literature

PTL 1 Japanese Patent Unexamined Publication No. S55-129326

### SUMMARY OF THE INVENTION

To solve the above-described problem, a strobe device of the present invention includes a light source formed longitudinally in one direction; an optical element placed in parallel with the longitudinal direction of the light source; and a reflector formed longitudinally in the longitudinal direction of the light source and having a reflecting surface that reflects light from the light source toward the optical element. The reflecting surface includes a first reflecting surface formed closer to the reflector than from a specific reflecting region in the reflecting surface; and a second reflecting surface formed closer to the optical element. Further, the first reflecting surface has a shape curved so as to have its center of curvature inside the reflector; the second reflecting surface has a shape curved so as to have its center of curvature outside the reflector and to be more remote from an optical axis with decreasing distance to the optical element.

With this structure, the second reflecting surface has a curved shape so as to have its center of curvature outside the reflector and to be more remote from the optical axis with decreasing distances to the optical element. Consequently, the second reflecting surface increases the incident angle (the angle from an axis orthogonal to second reflecting surface) of light emitted from the light source compared to a conventional strobe device. This allows the direction in which light reflected on the second reflecting surface travels to be approximated toward the direction of optical axis A. In other words, the incident angle of light that travels in the direction of optical axis A with the optical axis A can be decreased, thereby preventing light reflected on the second reflecting surface from illuminating part other than a desired region.

### BRIEF DESCRIPTION OF DRAWINGS

FIG. 1A is a sectional view illustrating a strobe device according to an exemplary embodiment of the present invention, in a state of the light source positioned closest to the reflecting surface of the reflector.

FIG. 1B is a sectional view illustrating the strobe device according to the exemplary embodiment, in a state of the light source positioned most remote form the reflecting surface of the reflector.

FIG. 2 illustrates the structure of the reflecting surface of the reflector of the strobe device according to the exemplary embodiment.

FIG. 3A is a graph for comparing the relative distribution of light amounts to the light distribution angles in a case where the light source emits light in a state of the light source positioned closest to the reflecting surface of the reflector, in the strobe device according to the exemplary embodiment and in an conventional strobe device.

FIG. 3B is a graph for comparing the relative distribution of light amounts to the light distribution angles in a case where the light source emits light in a state of the light source positioned most remote form the reflecting surface of the reflector, in the strobe device according to the exemplary embodiment and in the conventional strobe device.

FIG. 4A is a sectional view of the structure of the conventional strobe device, in a state of the light source positioned closest to the reflecting surface of the reflector.

FIG. 4B is a sectional view of the structure of the conventional strobe device, in a state of the light source positioned most remote from the reflecting surface of the reflector.

### DETAILED DESCRIPTION OF THE INVENTION

Hereinafter, a description is made of an exemplary embodiment of the present invention with reference to the related drawings. Note that this exemplary embodiment does not limit the scope of the present invention.

### Exemplary Embodiment

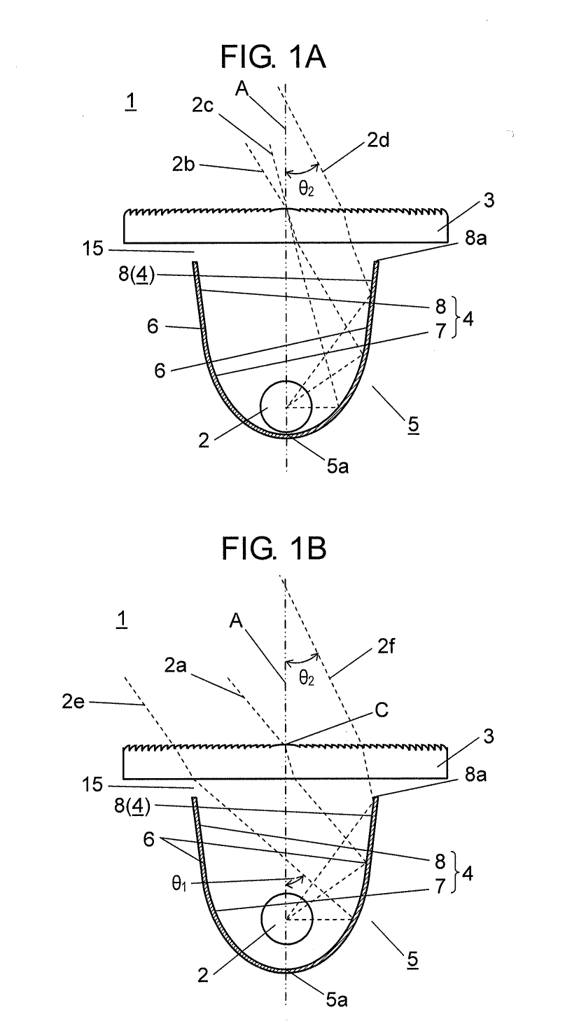

A description is made of a strobe device according to an exemplary embodiment of the present invention using FIGS. 1A and 1B.

As shown in FIGS. 1A and 1B, strobe device 1 of the exemplary embodiment includes: light source 2 formed longitudinally at least in one direction; optical element 3 placed in parallel with the longitudinal direction of light source 2; and reflector 5 formed longitudinally in the longitudinal direction of light source 2 and having reflecting surface 4 that reflects light from light source 2 toward optical element 3. Then, light source 2, optical element 3, and reflector 5 are arranged in the direction of optical axis A along optical axis A of strobe device 1. In this case, light source 2 uses a flash discharge tube such as a flash lamp.

Note that strobe device 1 basically accommodates the above-described components in a casing for instance, but the casing is omitted in the drawings for easy understanding.

Further, in strobe device 1 of the exemplary embodiment, light source 2 is displaceable relative to reflecting surface 4 of reflector 5 along the direction of optical axis A extending.

Hereinafter, a description is made of a case where light source 2 is displaced with respect to reflecting surface 4 of reflector 5 as an example. In other words, optical element 3 and reflector 5 are fixed; and light source 2 is displaced in the direction of optical axis A. Concretely, as shown in FIG. 1A, when light source 2 is closest to reflecting surface 4 of reflector 5, light source 2 is most remote from optical element 3. Meanwhile, as shown in FIG. 1B, when light source 2 is most remote from reflecting surface 4 of reflector 5, light source 2 is closest to optical element 3.

Optical element 3 is placed in parallel with the longitudinal direction of light source 2 formed longitudinally in the direction (vertical direction) orthogonal to the paper surface of FIG. 1A and orthogonally to optical axis A. Note that optical element 3 of the exemplary embodiment is formed of a Fresnel lens for instance.

In the same way, reflector 5 is symmetric with respect to optical axis A; has a substantially U-shaped cross section for instance; is in parallel with the longitudinal direction of light source 2; and is placed facing optical element 3 so as to contain light source 2.

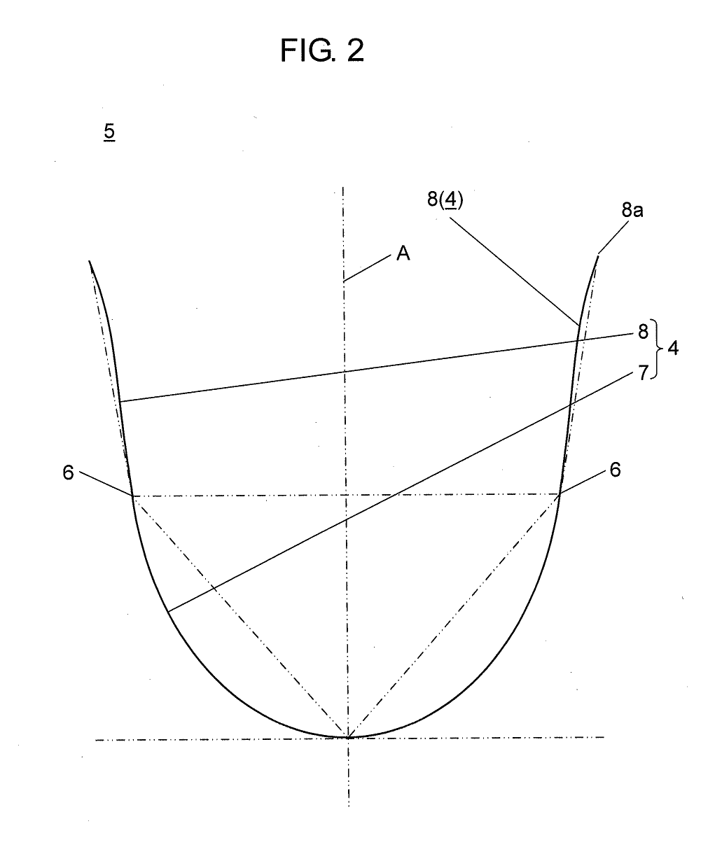

Next, a detailed description is made of the structure of the reflector of a strobe device according to the exemplary embodiment using FIG. 2.

FIG. 2 illustrates the structure of the reflecting surface of the reflector of the strobe device according to the exemplary embodiment. Note that FIG. 2 shows reflecting surface 4 of reflector 5 by a cross section taken along the direction orthogonal to the longitudinal direction of light source 2.

As shown in FIG. 2, reflecting surface 4 of reflector 5, symmetric with respect to optical axis A, includes two surfaces: first reflecting surface 7 and second reflecting surface 8 separated by specific reflecting region 6 of reflecting surface 4.

Here, specific reflecting region 6 of reflecting surface 4 is a region where reflected light 2a intersects reflecting surface 4, in a state where light source 2 shown in FIG. 1B is most remote from reflecting surface 4 at bottom 5a of reflector 5, where reflected light 2a is light reflected toward the center of optical element 3 among the entire reflected light that is light emitted from light source 2 and reflected on reflecting surface 4.

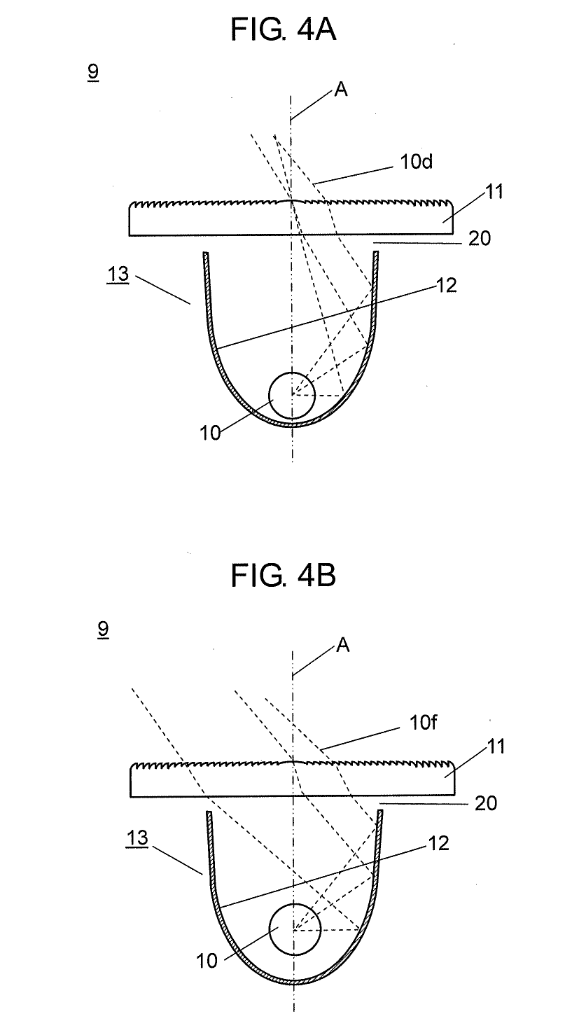

Then, first reflecting surface 7 of reflecting surface 4 is provided opposite to optical element 3 (closer to light source 2 than from specific reflecting region 6 in reflecting surface 4). In this case, first reflecting surface 7 of reflecting surface 4 has its center of curvature inside and is curved in a concave shape symmetric with respect to optical axis A. Note that having a center of curvature inside means that the center of curvature is positioned closer to optical axis A (toward optical axis A) than from reflecting surface 4 of reflector 5 shown in FIGS. 4A and 4B.

Meanwhile, second reflecting surface 8 of reflecting surface 4 is provided closer to optical element 3 than from specific reflecting region 6. In other words, second reflecting surface 8 is extendedly provided from both ends in the circumferential direction of first reflecting surface 7 corresponding to specific reflecting region 6, toward optical element 3. In this case, second reflecting surface 8 has its center of curvature outside reflector 5 and has a curved shape more remote from the optical axis A with decreasing distance to optical element 3. In other words, both ends 8a of second reflecting surface 8 closer to optical element 3 have a curved shape so that ends 8a are remote from each other.

As shown in FIGS. 1A and 1B, in reflector 5 of this embodiment, both ends 8a of second reflecting surface 8 of reflecting surface 4 closer to optical element 3 are placed a given distance (i.e., space 15) apart from optical element 3 in the direction of optical axis A. This allows heat generated by light emission from light source 2 to escape through space 15. Further, second reflecting surface 8 curved outward prevents temperature rise due to heat convection inside reflector 5, thereby allowing heat to escape outside reflector 5. This prevents degradation in the optical characteristics due to thermal deformation of optical element 3 for instance to achieve a reliable strobe device.

The above process forms strobe device 1 of the exemplary embodiment.

Hereinafter, a description is made of a strobe device of the exemplary embodiment that illuminates a region as an imaging target referring to FIGS. 1A and 1B. Note that the description is made of a case where strobe device 1 is provided directly or indirectly in an imaging device.

First, a description is made of a case of imaging in a state where setting is made so that a region as an imaging target is smallest using FIG. 1A.

As shown in FIG. 1A, light source 2 is moved to the position closest to bottom 5a of reflecting surface 4 of reflector 5.

In this case, among the light emitted from light source 2, reflected light 2b and 2c reflected on first reflecting surface 7 travels in the direction close to the direction of optical axis A.

Meanwhile, among the light emitted from light source 2, reflected light 2d reflected on second reflecting surface 8 of reflector 5 as well travels in the direction close to the direction of optical axis A, namely in the direction such that the incident angle of light that travels in the direction of optical axis A with the optical axis A decreases, which is because incident angle θ2 formed with the direction of optical axis A decreases.

Consequently, strobe device 1 of the exemplary embodiment is capable of collecting more reflected light and direct light to the central part of a region as an imaging target than reflected light 10d of the conventional strobe device shown in FIG. 4A.

Next, a description is made of a case of imaging in a state where setting is made so that a region as an imaging target is largest using FIG. 1B.

As shown in FIG. 1B, light source 2 is moved to the position most remote from optical element 3.

In this case, among the light emitted from light source 2, reflected light 2e reflected on first reflecting surface 7 of reflector 5 has larger incident angle θ1 formed with the direction of optical axis A, similarly to a case of the conventional strobe device.

Meanwhile, among the light emitted from light source 2, reflected light 2f reflected on second reflecting surface 8 of reflector 5 travels in the direction close to the direction of optical axis A, which is because incident angle θ2 formed with the direction of optical axis A decreases.

Consequently, strobe device 1 of the exemplary embodiment is capable of collecting reflected light 2f reflected on second reflecting surface 8 to the central part and its vicinity of a region as an imaging target as compared to reflected light 10f of the conventional strobe device shown in FIG. 4B.

As described above, strobe device 1 of the exemplary embodiment is capable of making reflected light reflected on second reflecting surface 8 of reflector 5 among the light emitted from light source 2 travel in the direction close to the direction of optical axis A. Accordingly, as shown in FIG. 1B, when light source 2 emits light in a case of light source 2 close to optical element 3, strobe device 1 prevents light emitted from light source 2 from illuminating part other than a desired region.

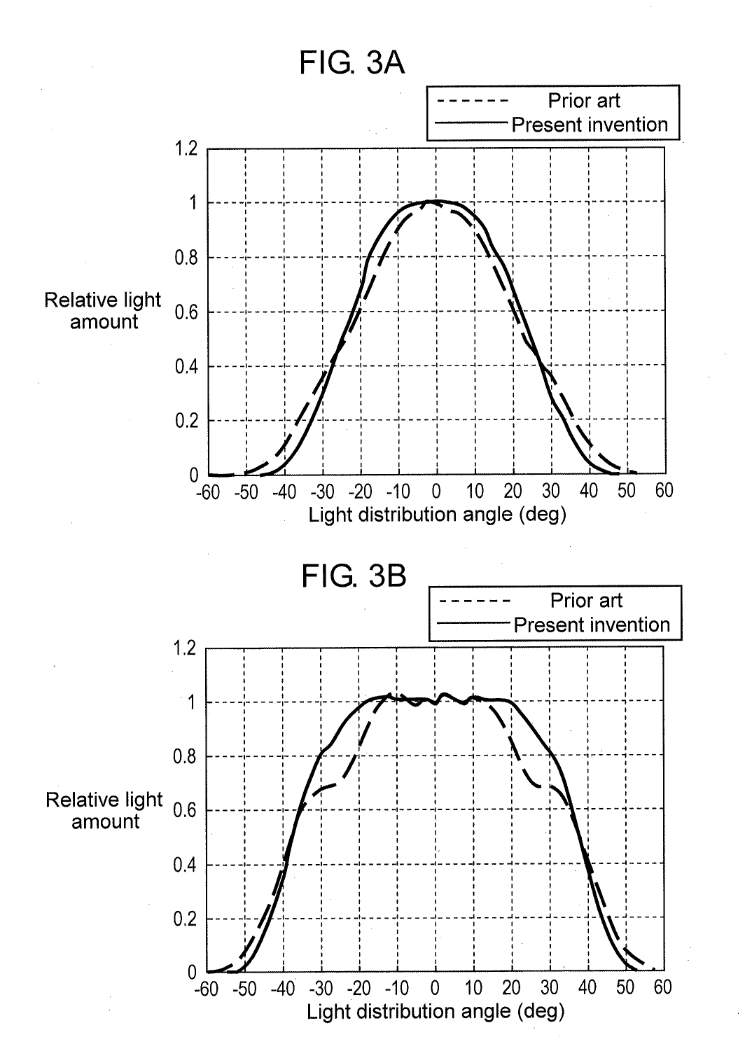

Hereinafter, a description is made of concrete advantages of the second reflecting surface of the reflector of the strobe device according to the exemplary embodiment using FIGS. 3A and 3B.

FIG. 3A is a graph for comparing the relative distribution of light amounts to the light distribution angles in a case where the light source emits light in a state of the light source positioned closest to the reflecting surface of the reflector, in the strobe device according to the exemplary embodiment and in an conventional strobe device. FIG. 3B is a graph for comparing the relative distribution of light amounts to the light distribution angles in a case where the light source emits light in a state of the light source positioned most remote form the reflecting surface of the reflector, in the strobe device according to the exemplary embodiment and in the conventional strobe device.

As shown in FIG. 3A, when light source 2 is made emit light in a state of light source 2 closest to reflecting surface 4 of reflector 5, light source 2 illuminates a position remote from the central part with a smaller amount of light than the conventional strobe device. In other words, the amount of light increases that illuminates the central part (the region with its light distribution angle between approximately −25 degrees and approximately 25 degrees) of the illuminated region.

That is, when light source 2 is made emit light in a state of light source 2 closest to reflecting surface 4, strobe device 1 of the exemplary embodiment is capable of collecting light that would illuminate a position remote from the central part of the illuminated region, to the central part.

Consequently, as shown in FIG. 3A, when imaging is performed with a region as an imaging target contracted, the amount of light that illuminates the entire region as an imaging target can be increased by making light source 2 emit light in a state of light source 2 closest to reflecting surface 4, compared to the conventional strobe device. Meanwhile, as shown in FIG. 3B, when light source 2 is made emit light in a state of light source 2 most remote from reflecting surface 4 of reflector 5, the amount of light decreases that illuminates positions remote from the central part of the illuminated region (regions with their light distribution angle larger than approximately 40 degrees or smaller than approximately −40 degrees). Then, the amount of light increases that illuminates the central part and its vicinity (regions with their light distribution angle between approximately 15 degrees and approximately 40 degrees and regions with its light distribution angle between approximately −15 degrees and approximately −40 degrees) of the illuminated region.

In other words, when strobe device 1 of the exemplary embodiment makes light source 2 emit light in a state of light source 2 most remote from reflecting surface 4, strobe device 1 is capable of collecting light that would illuminate positions (regions with their light distribution angle larger than approximately 40 degrees or smaller than approximately −40 degrees) remote from the central part of the illuminated region, to the central part and its vicinity.

Consequently, as shown in FIG. 3B, when imaging is performed with region R as an imaging target expanded. the amount of light that illuminates entire region R as an imaging target can be substantially or completely uniform by making light source 2 emit light in a state of light source 2 most remote from reflecting surface 4, compared to the conventional strobe device.

Note that the present invention is not limited to the above exemplary embodiment, but clearly, various types of modifications may be added within a scope that does not deviate from the gist of the present invention.

For example, in the above exemplary embodiment, the description is made of light source 2 formed longitudinally in one direction as an example, but not limited to this case. Light source 2 may be multiple LEDs arranged in one direction for instance, which provides a strobe device with a long operating life and low power consumption.

In the above exemplary embodiment, how the center of curvature of second reflecting surface 8 is configured is not especially mentioned. The reflecting surface may have a shape curved with a single center of curvature for instance. Alternatively, the reflecting surface may have a shape curved with its center of curvature changing as the reflecting surface approaches optical element 3. This allows reflected light reflected on second reflecting surface 8 to be collected within a desired range, thereby providing a strobe device for extensive applications.

In the above exemplary embodiment, the description is made of the configuration in which light source 2 is displaced with respect to reflecting surface 4 of reflector 5 as an example, but not limited to this case. For example, a configuration may be used in which the positions of light source 2 and optical element 3 are fixed and reflecting surface 4 of reflector 5 is displaced with respect to light source 2. Another alternative is a configuration in which both light source 2 and reflecting surface 4 of reflector 5 are displaced with respect to optical element 3. Further, a configuration may be used in which optical element 3 is displaced with respect to light source 2 and reflecting surface 4 of reflector 5. These configurations provide a versatile strobe device that allows setting various ranges of the amount of light for illumination according to an application.

In the above exemplary embodiment, the description is made of the configuration in which light source 2 is displaced with respect to reflecting surface 4 of reflector 5, but not limited to this case. For example, a configuration may be used in which light source 2, optical element 3, and reflector 5 are fixed. This eliminates the need for a mechanism that displaces light source 2 and other components, which provides a strobe device with a simplified structure.

In the above exemplary embodiment, the description is made of the example where specific reflecting region 6 of reflecting surface 4 is a region where reflected light 2a intersects reflecting surface 4, in a state of light source 2 most remote from reflecting surface 4, where reflected light 2a is light reflected toward the center of optical element 3 among the entire reflected light that is light emitted from light source 2 and reflected on reflecting surface 4, but not limited to this case. Specific reflecting region 6 may be provided at any position within a range where light emitted from light source 2 is prevented from illuminating part other than a desired region, as long as reflecting surface 4 can be separated into first reflecting surface 7 and second reflecting surface 8. This provides a strobe device that illuminates a desired range with a given amount of light according to a desired application.

In the above exemplary embodiment, the description is made of the example where specific reflecting region 6 of reflecting surface 4 is a region where reflected light 2a intersects reflecting surface 4, in a state of light source 2 most remote from reflecting surface 4, where reflected light 2a is light reflected toward the center of optical element 3 among the entire reflected light that is light emitted from light source 2 and reflected on reflecting surface 4, but not limited to this case. For example, a specific reflecting region may be determined for a state of light source 2 closest to bottom 5a of reflecting surface 4. Further, for a strobe device configured so that light source 2 and other components are not displaced, a specific reflecting region may be determined for a fixed state. This configuration provides a versatile strobe device that illuminates a desired range with a given amount of light according to a desired application.

As described hereinbefore, a strobe device of the present invention includes a light source; an optical element; and a reflector having a reflecting surface. The reflecting surface includes a first reflecting surface formed closer to the reflector than from the specific reflecting region in the reflecting surface; and a second reflecting surface formed closer to the optical element. Further, the first reflecting surface has a shape curved so as to have its center of curvature inside the reflector; the second reflecting surface has a shape curved so as to have its center of curvature outside the reflector and to be more remote from an optical axis with decreasing distance to the optical element.

With this structure, the second reflecting surface has its center of curvature outside and has a curved shape more remote from the optical axis with decreasing distance to the optical element. Consequently, the second reflecting surface increases the incident angle (the angle from an axis orthogonal to the second reflecting surface) of light emitted from the light source, compared to a conventional strobe device. This allows the direction in which light reflected on the second reflecting surface travels to be approximated toward the direction of optical axis A. In other words, the incident angle of light that travels in the direction of optical axis A with the optical axis A can be decreased, thereby preventing light reflected on the second reflecting surface from illuminating part other than a desired region.

In a strobe device of the present invention, the specific reflecting region of the reflecting surface may be a region where reflected light intersects the reflecting surface, in a position most remote from the reflecting surface at the bottom of the reflector, where the reflected light is light reflected toward the center of the optical element among the entire reflected, light that is light emitted from the light source and reflected on the reflecting surface.

A strobe device of the present invention may be configured so that at least either one of the light source and the reflector is displaced relative to the optical element along the direction of the optical axis. This allows an illumination-target region to be freely determined while effectively preventing light from illuminating part other than a desired region.

### INDUSTRIAL APPLICABILITY

The present invention is useful in the technical field of lighting devices such as a strobe device incorporated into an imaging device that requires light from a light source to illuminate part within a desired region.

### REFERENCE MARKS IN THE DRAWINGS

1, 9 Strobe device
2, 10 Light source
2a, 2b, 2c, 2d, 2e, 2f, 10d, 10f Reflected light
3, 11 Optical element
4, 12 Reflecting surface
5, 13 Reflector
5a Bottom
6 Specific reflecting region
7 First reflecting surface
8 Second reflecting surface
8a End
15, 20 Space

1. A strobe device comprising:
a light source formed longitudinally in one direction;
an optical element disposed in parallel with the light source; and
a reflector formed longitudinally in a longitudinal direction of the light source and having a reflecting surface that reflects light from the light source toward the optical element,
wherein the reflecting surface includes:
a first reflecting surface formed closer to the reflector than from a specific reflecting region in the reflecting surface; and
a second reflecting surface formed closer to the optical element,
wherein the first reflecting surface has a shape curved so as to have a center of curvature inside the reflector,
wherein the second reflecting surface has a shape curved so as to have a center of curvature outside the reflector and to be more remote from an optical axis with decreasing distance to the optical element,
wherein the strobe device is configured so that at least either one of the light source and the reflector is displaced relative to the optical element along a direction of the optical axis, and
wherein the specific reflecting region is configured so that reflected light in the specific reflecting region is reflected toward a center of the optical element when the light source is most remote from a bottom of the reflector.

2. The strobe device of claim 1, wherein the specific reflecting region of the reflecting surface is a region at which, among reflected light emitted when the light source is in a position most remote from the reflecting surface at a bottom of the reflector, the reflected light reflected toward a center of the optical element intersects the reflecting surface.

3. The strobe device of claim 1 configured so that at least either one of the light source and the reflector is displaced with respect to the optical element along a direction of the optical axis.
